(19) United States
(12) Patent Application Publication
(10) Pub. No.: US 2003/0001022 A1
(43) Pub. Date: Jan. 2, 2003

(54) Liquid control cup

(76) Inventor: Michael Edward Writt, Indianapolis, IN (US)

Correspondence Address: Michael E. Writt, 7155 Wadsworth Way, Indianapolis, IN, 46219, US

(21) Appl. No.: 10/046,606

(22) Filed: Apr. 3, 2002

Related U.S. Application Data
(60) Provisional application No. 60/302,000, filed on Jul. 2, 2001.

(51) Int. Cl. A61J 15/00

(52) U.S. Cl. 239/33

(57) ABSTRACT

This device allows a specific amount of fluid to be delivered independently to a person who must be limited on the amount of fluid they can drink at one time. Without outside help or without making any adjustments to the cup.

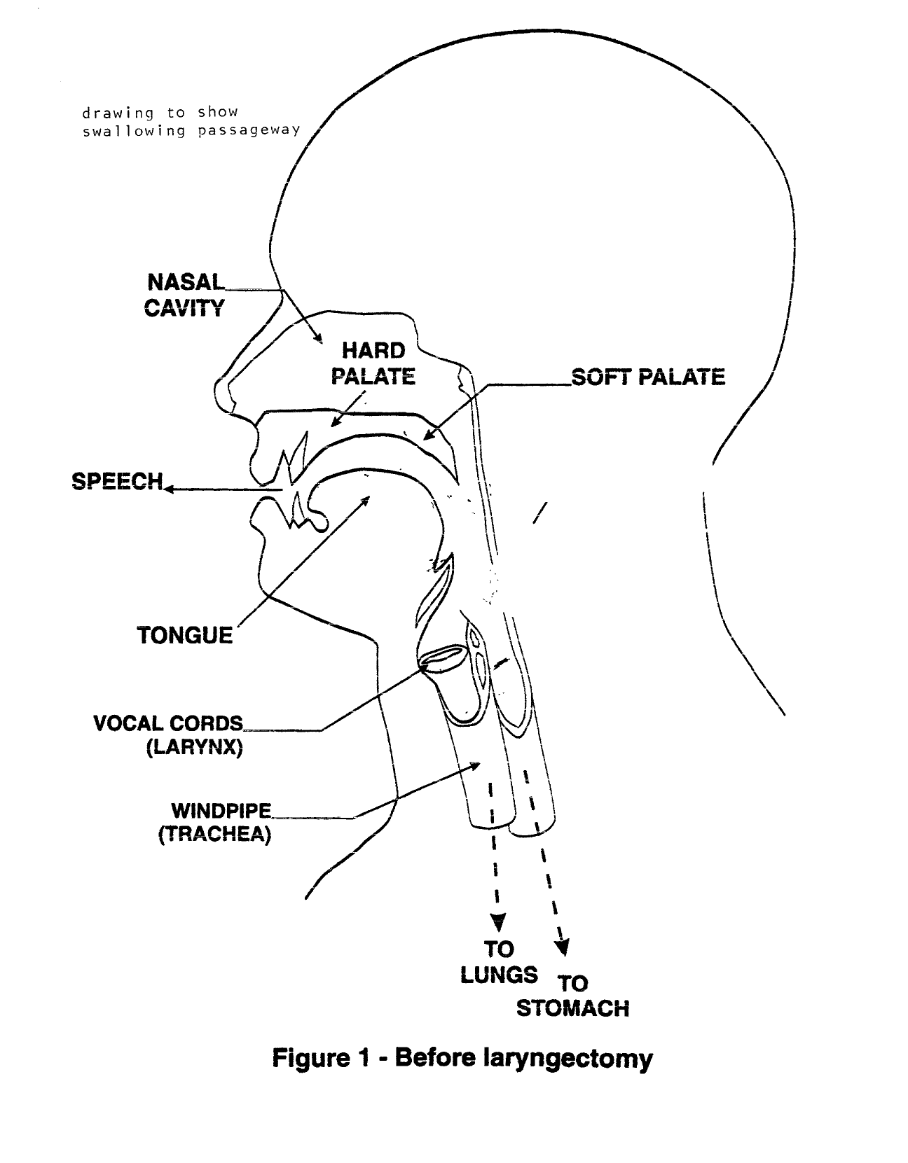

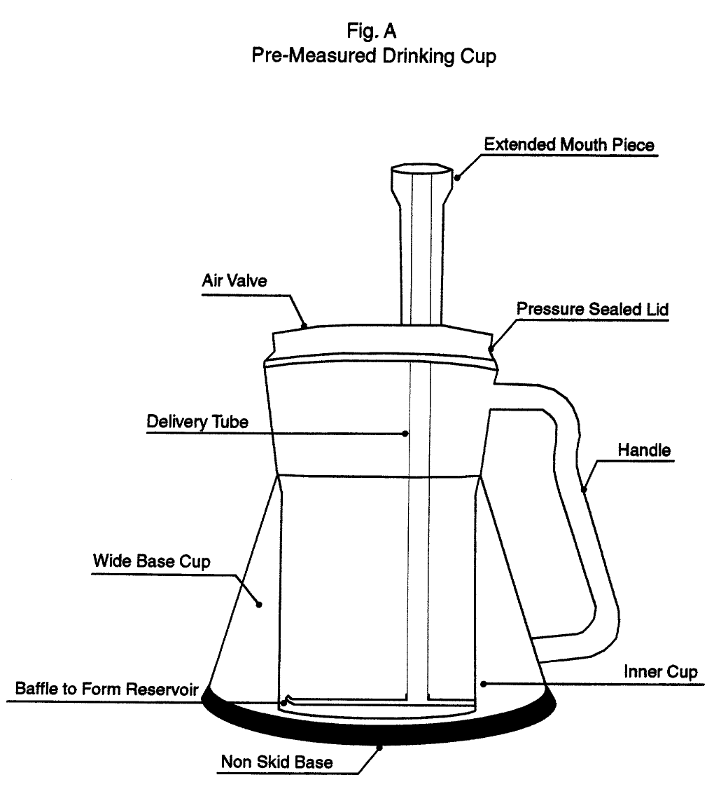

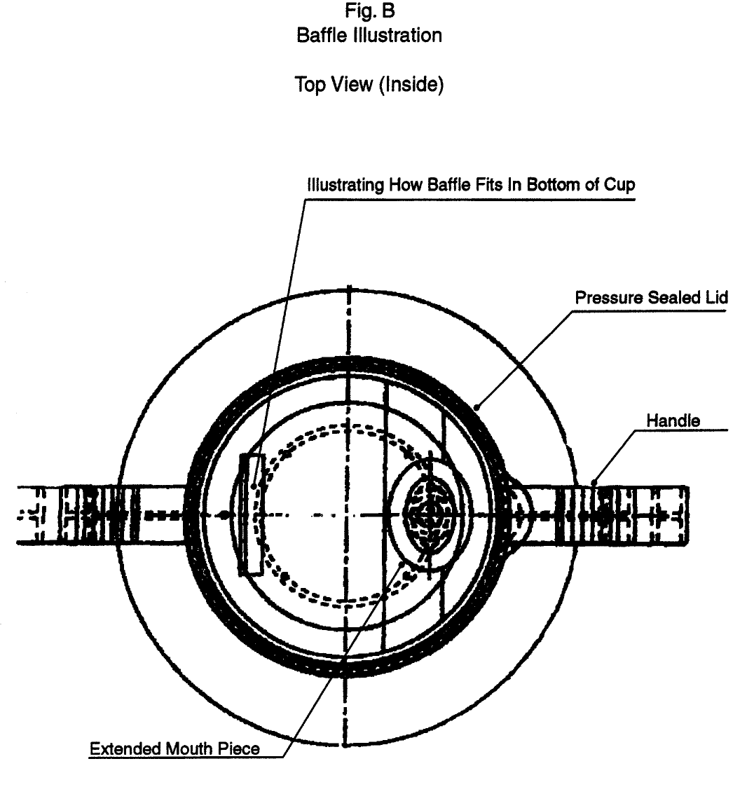

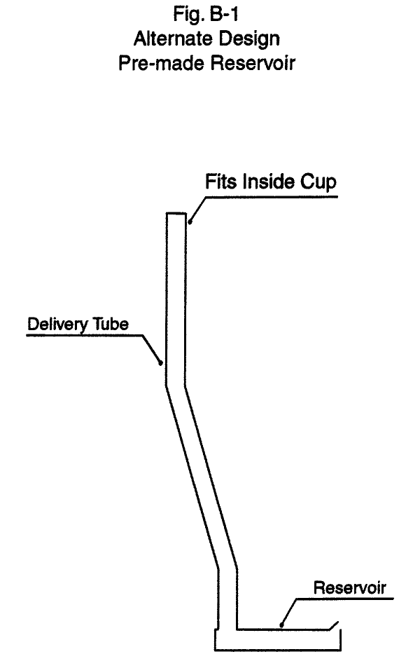

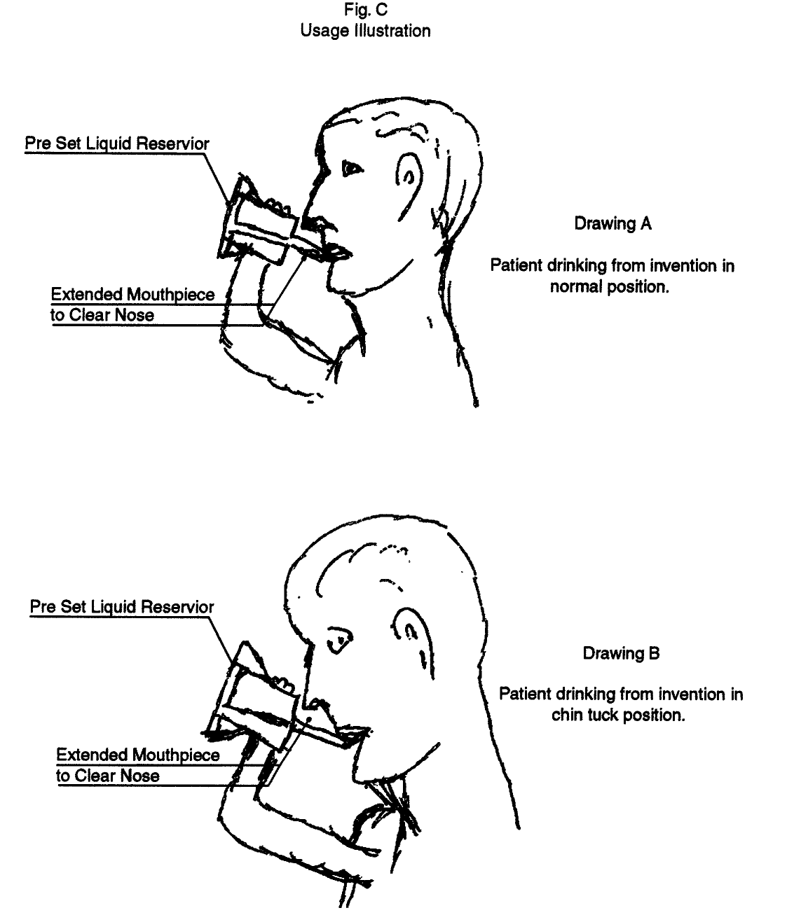

### REFERENCE TO RELATED APPLICATIONS

This application is a continuation in part of provisional patient No. 60/302,000 filed Jul. 2, 2001.

### FIELD OF INVENTION

This invention allows anyone that has lost the involuntary control of swallowing, to consume frequent small amounts of fluids independently without help from care giver. This not only returns some dignity to the patient using the device but allows the care giver the freedom to perform other duties needed by the patient. Thus allowing the care giver the time to provide care to more patients. The patient can drink when they wish. This provides them with a better quality of life and can help prevent dehydration as well as promote a faster recovery.

### BACKGROUND OF THE INVENTION

Therefore the need for a device to allow patients to drink small amounts of liquids on their own, without help or dependency on anyone to help them. The care giver must feed the patient's the liquid they need by hand in small amounts, a teaspoon at a time. One ounce of liquid contains six teaspoons. The patients chin is tucked down to their chest to open the passageway to the stomach and prevent aspiration. This takes a large amount of time on the part of the care giver and is very expensive. And limits the amount of care a person can provide. This invention will eliminate the need for the care giver to administer the liquid by hand with a teaspoon. The patient can get liquid when they need it independently of the care giver. It is also important that the device be made to prevent the patient from getting large amounts of liquid, that would cause them to aspirate and possibly choke. This invention does this, it allows only the liquid held in the reservoir to be delivered to the patient when the cup is held up to the mouth and tipped toward the mouth. The device is set up right to refill the reservoir and deliver another pre-set amount of liquid to the patient.

### SUMMARY OF INVENTION

This invention allows anyone with swallowing problems to drink liquid, anytime they want or need to drink. And to do this without help from anyone. Giving them more independence and control over themselves. The invention provides the proper amount of liquid to help prevent aspiration, while keeping the patient hydrated. Which prevents further deterioration of their health. The cup consists of two pieces. The cup that holds the liquid. The insert encompassing the extended mouth piece, lid, delivery tube and baffle plate or complete reservoir. This design allows for easy and complete cleaning.

1. Cup, to hold liquids

2. Lid, delivery tube and baffle plate or reservoir to hold pre-measured amount of liquid. The baffle plate along with the side and bottom of the cup forms the reservoir in this design.

### CLAIM OR CLAIMS

What I claim my invention is. It is a device that delivers a pre-set amount of liquid for a person who is restricted on the amount of liquid they can drink

### DESCRIPTION OF THE PREFERRED EMBODIMENTS

For the purposes of promoting and understanding of the principles of the invention. Reference will now be made to the embodiments illustrated in the drawings. It will nevertheless be understood that no limitations of the scope of the invention is thereby intended, such alterations and further modifications in the illustrated device, and such further applications of the principles of the invention as illustrated therein being contemplated as would normally occur to one skilled in the art to which the invention relates.

While the invention will be described below for reference to a medical setting, it should be appreciated that the present invention can be adapted for use in other situations where fluid control is a concern.

Add liquid to cup, place lid containing mouth piece, delivery tube and baffle plate that completes reservoir in cup making sure lid is secure. The reservoir will fill with liquid when submerged into the liquid. When cup is tipped up to drink, liquid is held in reservoir will flow through the tube into the mouth piece into the patients mouth. The remaining liquid will stay in the cup. The process of filling the reservoir will be repeated. By placing the cup in a up right position forcing liquid to the bottom of the cup refilling reservoir. When cup is raised toward the mouth and tilting the bottom upward placing the top of the cup in a downward position. And the bottom of the cup to the higher position forcing the liquid through the tube to the mouth piece.

Lid is vented to allow air flow from cup without forcing liquid out of the cup when the lid is put on the cup. And to allow air to reenter cup, helping the free flow of liquid. Cup can also be designed having a false bottom with a reservoir below the false bottom. The false bottom will have an opening to allow liquids to flow into reservoir below false bottom and be delivered to the patients mouth from the reservoir through the delivery tube without help. Cup can have one or two handles or no handle which ever is best.

While the invention has been illustrated and described in detail in the drawings and descriptions, the same is to be considered as illustrative and not restrictive in charter, it being understood that only the preferred embodiment has been shown and described and that all changes and modifications that come within the spirit of the invention are desired to be protected.

What I claim my invention is:

1. Pre-measured, pre-set device to deliver the same amount of liquid each time a person drinks. Designed and developed for people who aspirate or choke from taking large amount of liquids. When they drink from a normal drinking vessel.
Is a device when placed in a cup, glass or other drinking vessel restricts the amount of liquid that flows from the vessel to the person drinking. It is a device that dispenses a pre-deter amount of liquid each time the person drinks. The device can be constructed to dispense any amount of liquid for a particular reason.
